(19) United States
(12) Patent Application Publication
(10) Pub. No.: US 2022/0134326 A1
(43) Pub. Date: May 5, 2022

(54) AID DEVICE AND METHODS FOR EMPTYING CONTENT FROM A TUBE AND FILLING CONTENT INTO A TUBE

(71) Applicant: DANDY INNOVATIONS LTD., Rosh HaAyin (IL)

(72) Inventor: David CHEKROUN, Rosh HaAyin (IL)

(21) Appl. No.: 17/518,801

(22) Filed: Nov. 4, 2021

(30) Foreign Application Priority Data
Nov. 5, 2020 (IL) 278534

(51) Int. Cl. B01L 3/02

(52) U.S. Cl. CPC B01L 3/0224; B01L 2200/0605; B01L 2200/087; B01L 2400/0478; B01L 2300/0609; B01L 2300/0663; B01L 2300/0681; B01L 2200/146

(57) ABSTRACT

An aid device, for manually emptying contents of a tube, including: a housing, a clamp, coupled to the housing and configured to secure a position of the tube in relation to the housing, wherein the tube includes a plunger configured to slide within the tube between an inlet end of the tube and an outlet end of the tube, a pusher configured to abut the plunger, and a lever pivotally coupled to the pusher by a first rotational axis such that the lever is continuously rotatable between an open configuration and a closed configuration about the first rotational axis, thereby facilitating a continuous movement of the pusher from the open configuration to the closed configuration, wherein the clamp is configured to secure the position of the tube such that the plunger of the tube is positioned between the outlet end of the tube and the pusher.

### TECHNICAL FIELD

The present invention relates to aid devices configured to aid in content insertion into and/or ejection from a test tube or syringe. More particularly, the present invention relates to an aid device configured to aid with the operation of a tube, such as a syringe or test tube.

### BACKGROUND

As of today, syringes are frequently used in analytical chemistry and life sciences industry. Clinical research and lab techniques, may require repetitive use of syringes. In some cases, the syringe maybe full with a viscous material, or even a material that has a high viscosity, which makes the use of the syringe even more difficult. This may include emptying the syringe or filling the syringe. The repetitive operation of the syringe may uncomfortable to the user, and even more so when the material within the syringe is viscous.

Syringes are also commonly used when filtering material through a filter. When the filtered content contains a high percent of precipitates, or has a high viscosity, the use of the syringe becomes more difficult. The operation of ejecting this content from the syringe may require the user to apply force onto the plunger of the syringe in order to eject the content. When this operation is repeated over time, it may cause damage to the hand of the user, as well as risk the accuracy of the outcome of the ejection of the material.

US 2012181773 discloses a belt driven infusion pump for emptying the contents of a syringe. The pump includes a syringe pusher including an antisiphon catch and a pressure detector which is used for detecting occlusions or the end of infusion. A syringe clamp for locking a syringe in place is also provided. The syringe clamp is spring-loaded and lockable. A syringe position detector is provided to ensure the proper placement of the syringe prior to and during pumping. A control knob is provided on the face of the pump for controlling both the locking of the syringe barrel clamp and the coupling of the drive belt with a motor. The pump includes a housing having an elongated slot through which the syringe pusher is connected to the drive belt. A pole clamp assembly is incorporated within the pump housing and includes a clamping arm for securing the pole between the clamping arm and the housing. The clamping arm is movable to a storage position where it is substantially flush with the outer surface of the pump housing. Nevertheless, the described infusion pump is costly.

WO2020070328A1 discloses an auto injector for delivery of administering a medicament comprising: a housing; an electrical motor adapted to move a piston between proximal and distal positions in a longitudinal direction of the auto injector; a syringe holder extending from a proximal to a distal end and configured to receive a syringe, a spring adapted for moving the syringe holder with the syringe proximally for insertion of the needle. Nevertheless, the described infusion pump is costly.

It would therefore be desired to propose a system void of these deficiencies.

### SUMMARY

According to some embodiments of the present invention there is provided an aid device, for manually emptying contents of a tube, including: a housing, a clamp, coupled to the housing and configured to secure a position of the tube in relation to the housing, wherein the tube includes a plunger configured to slide within the tube between an inlet end of the tube and an outlet end of the tube, a pusher configured to abut the plunger, and a lever pivotally coupled to the pusher by a first rotational axis such that the lever is continuously rotatable between an open configuration and a closed configuration about the first rotational axis, thereby facilitating a continuous movement of the pusher from the open configuration to the closed configuration, wherein the clamp is configured to secure the position of the tube such that the plunger of the tube is positioned between the outlet end of the tube and the pusher.

According to some embodiments of the present invention there is provided a method including: providing an aid device including: a housing, a clamp coupled to the housing and configured to secure a position of the tube in relation to the housing, a pusher configured to abut the plunger, and a lever pivotally coupled to the pusher by a first rotational axis such that the lever is continuously rotatable between an open configuration and a closed configuration about the first rotational axis, thereby facilitating a continuous movement of the pusher from the open configuration to the closed configuration, securing a tube to the housing using the clamp, and rotating the lever about the first rotational axis, thereby pushing the pusher towards the clamp such that the plunger is pushed from an inlet end of the tube towards an outlet end of the tube while moving the lever from the open configuration to the closed configuration.

According to some embodiments of the present invention there is provided a method for filtering a substance through a tube, the method including: providing an aid device including: a housing, a clamp coupled to the housing and configured to secure a position of the tube in relation to the housing, a pusher configured to abut the plunger, and a lever pivotally coupled to the pusher by a first rotational axis such that the lever is continuously rotatable between an open configuration and a closed configuration about the first rotational axis, thereby facilitating a continuous movement of the pusher from the open configuration to the closed configuration, securing tube to the housing using the clamp, wherein the tube includes a filter attached to an end thereof, and rotating the lever about the first rotational axis, thereby pushing the pusher towards the clamp such that the plunger is pushed from an inlet end of the tube towards an outlet end of the tube, while moving the lever from the open configuration to the closed configuration.

According to some embodiments, the lever is pivotally coupled to the housing by a second axis of rotation.

According to some embodiments, the second axis of rotation is pivotally coupled to a second lever.

According to some embodiments, the second lever is pivotally coupled to the housing by a third axis of rotation.

According to some embodiments, the tube includes a filter attached to an end thereof.

According to some embodiments, the housing further includes a rail, and the pusher is slidably coupled to the rail such that rotation of the lever initiates movement of the pusher within the rail.

According to some embodiments, the aid device is devoid of gears.

According to some embodiments, the clamp includes two protrusions for holding the tube.

According to some embodiments, the aid device further includes springs located between the protrusions and the housing, the springs being configured for pressuring the protrusions towards each other.

According to some embodiments, the aid device is ergonomic.

According to some embodiments, the device further includes at least one sensor configured to detect an amount of force applied to/by the pusher and/or to the plunger, and one or more buttons in communication with the one or more sensors and coupled to the pusher, and wherein for a predetermined amount of force, the buttons are configured to prevent movement of the pusher.

According to some embodiments of the Method for emptying contents of a tube, the

According to some embodiments, the lever is pivotally coupled to the housing by a second axis of rotation, and wherein moving the lever from the open configuration to the closed configuration includes rotating the lever about the second axis of rotation.

According to some embodiments, the second axis of rotation is pivotally coupled to a second lever and the second lever is pivotally coupled to the housing by a third axis of rotation, and wherein moving the lever from the open configuration to the closed configuration includes rotating the lever about the first axis of rotation and/or about the second axis of rotation.

According to some embodiments, moving the lever from the open configuration to the closed configuration includes rotating the second lever about the third axis of rotation.

According to some embodiments, the housing further includes a rail, and wherein moving the lever from the open configuration to the closed configuration sliding the pusher along the rail.

It is an object of the present invention to provide an aid to manually and easily empty a syringe.

It is another object of the present invention to provide a reusable manual aid, for operating a syringe.

It is still another object of the present invention to provide a syringe aid capable of accommodating and operating different syringes having different sizes.

It is still another object of the present invention to provide an ergonomic syringe aid for transferring the required pressure force from the thumb/fingers to the hand/arm.

It is still another object of the present invention to provide an aid, for easily emptying a syringe, where the syringe has a filter attached to its tip.

Other objects and advantages of the invention will become apparent as the description proceeds.

The present invention relates to a syringe aid device, for manually emptying the syringe, including: (a) a housing, (b) a clamp, located within the housing, for holding the barrel of the syringe and for preventing the barrel from moving, (c) a pusher for pushing the plunger flange, of the syringe, towards the barrel flange of the syringe, (d) a lever, pivotally connected to the pusher, where the lever is rotatable between an open configuration and a closed configuration, and (e) wherein when a filled syringe is inserted on the housing, while the syringe barrel is held by the clamp and while the plunger flange is located between the pusher and the clamp, and when the lever is moved, from the open configuration to the closed configuration, the lever pushes the pusher towards the clamp, thereby emptying the syringe by pushing the plunger flange of the syringe towards the syringe barrel flange.

Preferably, the clamp includes 2 protrusions for holding the barrel of the syringe.

Preferably, the lever of the device is transparent.

In one embodiment, the pusher of the device has a cavity for holding the plunger flange, of the syringe.

### BRIEF DESCRIPTION OF THE DRAWINGS

The accompanying drawings, and specific references to their details, are herein used, by way of example only, to illustratively describe some of the embodiments of the invention.

In the drawings:

FIG. 1A and FIG. 1B are schematic illustrations of an aid device with a syringe and a tube with a filter, respectively, at an open configuration of the aid device, in accordance with some embodiments of the present invention;

FIG. 2 is a schematic illustration of an aid device with a syringe, at a closed configuration of the aid device, in accordance with some embodiments of the present invention;

FIG. 3A and FIG. 3B are schematic illustrations of an aid device with a syringe, at an open configuration of the aid device and a closed configuration of the aid device, respectively, in accordance with some embodiments of the present invention;

FIG. 4A and FIG. 4B are exploded schematic illustrations of exemplary aid devices, in accordance with some embodiments of the present invention;

FIG. 5 is a schematic illustration of a portion of the aid device, in accordance with some embodiments of the present invention;

FIG. 6A, FIG. 6B, and FIG. 6C are side view schematic illustrations of a portion of the aid device at an open configuration, a semi-closed configuration, and a closed configuration, respectively, in accordance with some embodiments of the present invention;

FIG. 7A, FIG. 7B, FIG. 7C, and FIG. 7D are top view, side view, cross sectional view, and perspective view schematic illustrations of an aid device at an open configuration thereof, in accordance with some embodiments of the present invention;

FIG. 8A, FIG. 8B, FIG. 8C, and FIG. 8D are top view, side view, cross sectional view, and perspective view schematic illustrations of an aid device at a semi-closed configuration thereof, in accordance with some embodiments of the present invention;

FIG. 9A, FIG. 9B, FIG. 9C, and FIG. 9D are top view, side view, cross sectional view, and perspective view schematic illustrations of an aid device at a closed configuration thereof, in accordance with some embodiments of the present invention;

FIG. 10A and FIG. 10B are exemplary tubes for use with an aid device, in accordance with some embodiments of the present invention;

FIG. 11A, FIG. 11B, and FIG. 11C are top view, side view, and perspective view schematic illustrations of an anchoring device for the aid device, in accordance with some embodiments of the present invention;

FIG. 11D is a side view schematic illustration of an anchoring device for the aid device coupled to a stand, in accordance with some embodiments of the present invention;

FIG. 12 is a flow chart of steps of a method for emptying contents of a tube using an aid device, in accordance with some embodiments of the present invention; and

FIG. 13 is a flow chart of steps of a method for filtering a substance through a tube using an aid device, in accordance with some embodiments of the present invention.

### DETAILED DESCRIPTION

The principles, uses and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

In the following description, various aspects of the invention will be described. For the purpose of explanation, specific details are set forth in order to provide a thorough understanding of the invention. However, it will also be apparent to one skilled in the art that the invention may be practiced without specific details being presented herein. Furthermore, well-known features may be omitted or simplified in order not to obscure the invention.

The terms of “front”, “rear”, “down”, “up”, “bottom”, “upper”, “above”, “below”, or any reference to sides or directions are used throughout the description for the sake of brevity alone and are relative terms only and not intended to require a particular component orientation.

As of today, syringes may come in a number of different sizes and diameters, however, in typical syringes the distance between the plunger flange and the barrel flange of the syringe, when the syringe is full, is limited to a constant predetermined length. This distance, between the plunger flange and the barrel flange, is typically limited to a distance that would be comfortable for use of a user, between the tip of the thumb and the distal phalanx, of the index finger, of a standard human hand. Thus, although syringes may come in different diameter sizes, their plungers, however, are typically limited to a certain length.

The operation of emptying a syringe, that is, the pushing of the plunger flange towards the barrel flange, while holding the barrel flange, is uncomfortable to the human hand and when done many times, such as the practice in many labs around the world, the consequences may be harmful to the operator's hand, especially when the contents of the syringe may have a high viscosity. Furthermore, in some cases, a filter is added to the syringe's tip (or outlet end), effectively making the operation of emptying the syringe, through the filter, even more harmful to the operator's hand.

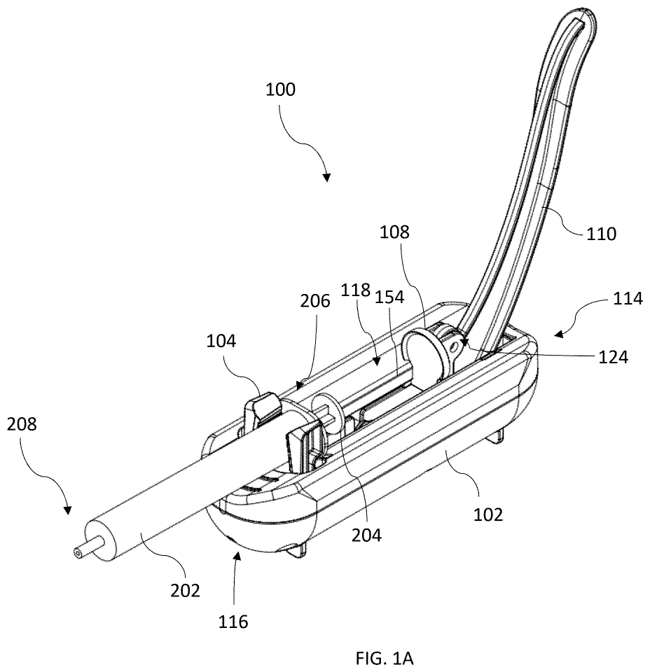

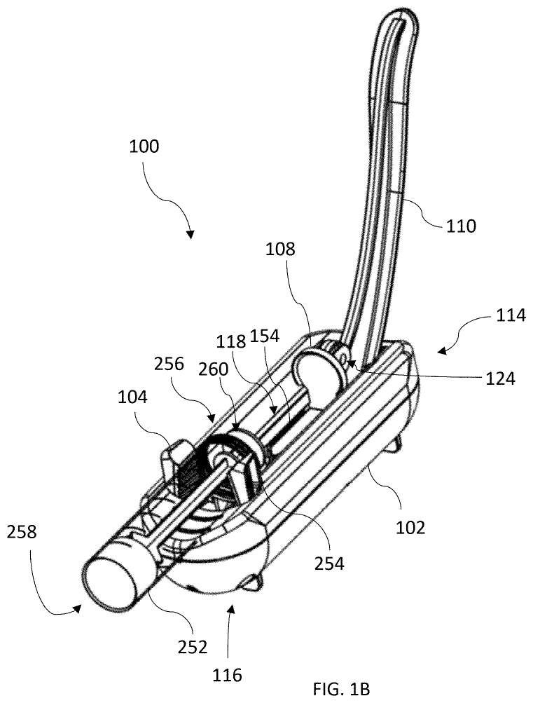

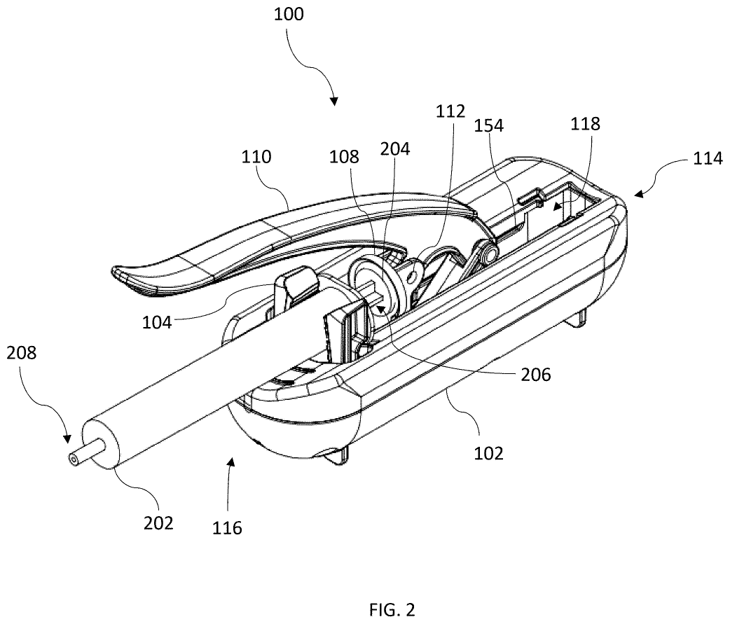

Reference is made to FIG. 1A and FIG. 1B, which show schematic illustrations of an aid device with a syringe and a tube with a filter, respectively, at an open configuration of the aid device, in accordance with some embodiments of the present invention, and to FIG. 2, which shows a schematic illustration of an aid device with a syringe, at a closed configuration of the aid device, in accordance with some embodiments of the present invention.

According to some embodiments, the aid device 100 may be configured to aid a user in manually emptying contents of a tube 202/252/350. According to some embodiments, the aid device 100/300 may be configured to support the tube 202/252/350, such as, for example, a syringe (such as, for example, the syringe depicted by FIG. 1A), a test tube (such as, for example, the test tube depicted by FIG. 1B), and the like. According to some embodiments, the aid device 100/300 may be configured to aid a user in pressing (or pushing) a plunger 204/256/357 within the tube. According to some embodiments, the aid device 100/300 may be configured to aid a user in pressing (or pushing) a plunger 204/256/357 through a lumen of the tube 202/252/350. According to some embodiments, the plunger 204/256/357 may be configured to slide within the tube 202/252/350 between an inlet end 206/260/362 of the tube 202/252/350 and an outlet end 208/258/365 of the tube 202/252/350.

According to some embodiments, the aid device 100 may include a housing 102. According to some embodiments, the aid device 100 may include a clamp 104 configured to secure a position of the tube in relation to the housing 102. According to some embodiments, the aid device 100 may include a pusher 108 configured to abut the plunger 204/256/357 of the tube 202/252/350. According to some embodiments, the aid device 100 may include a (first) lever 110 that is pivotally coupled to the pusher 108. According to some embodiments, the (first) lever 110 may be coupled to the pusher 108 by a first rotational axis 124. According to some embodiments, the lever 110 may be pivotally coupled to the pusher 108 by the first rotational axis 124 such that the lever 110 is continuously rotatable between an open configuration (such as depicted in FIG. 1) and a closed configuration (such as depicted in FIG. 2) about the first rotational axis.

According to some embodiments, the housing 102 may include an elongated body having a distal end 114 and a proximal end 116. According to some embodiments, the housing 102 may be composed of a rigid or semi-rigid material. According to some embodiments, the housing may be configured to support any one or more of the clamp 104, the lever 110 and the pusher 108. According to some embodiments, the housing may include an opening 118 configured to fit at least a portion of the pusher 108 therethrough. According to some embodiments, the pusher 108 may slidable within (or along a portion of) the opening 118.

According to some embodiments, the terms “rotational axis” and “axis of rotation” as used herein may be interchangeable and may refer to an axis about which an element (such as, for example, the lever) may rotate.

According to some embodiments, the opening 118 may extend from the distal end 114 to a proximal end 116 of the body of the housing 102. According to some embodiments, the opening 118 may be configured to fit at least a portion of the lever 110 therethrough. According to some embodiments, the lever 110 may move through the opening 118 during the rotation of the lever 110 (or in other words, the position of the lever 110 within the opening 120 may be different at an open configuration and a closed configuration of the aid device.

According to some embodiments, the clamp may be positioned near the proximal end 116 of the body of the housing 102. According to some embodiments, the opening 118 may extend towards the proximal end 116 of the body of the housing 102. According to some embodiments, the clamp 104 may be positioned at the end of the opening 118. According to some embodiments, the clamp 104 may be positioned near the end of the opening 118.

According to some embodiments, the clamp 104 may be configured to hold the tube 202/252/350, or in other words, fix the position of the tube 202/252/350. According to some embodiments, the clamp 104 may be configured to hold the tube 202/252/350, regardless of the dimensions of the tube (such as, for example, the length, width, diameter, and the like). According to some embodiments, the clamp 104 may be configured to hold a plurality (and/or a variety) of different types of tubes. According to some embodiments, the clamp 104 may be configured to hold a plurality (and/or a variety) of tubes having different dimensions.

According to some embodiments, the clamp 104 may include a rigid or semi-rigid holder configured to hold a tube 202/252/350. According to some embodiments, the clamp 104 may include a mechanism for applying pressure (and/or light pressure) onto the tube 202/252/350 positioned therein, such that the position of the tube 202/252/350 is maintained fixed in relation to the clamp 104 and/or housing 202/252/350. According to some embodiments, the clamp 104 may be coupled to the housing 102 directly or indirectly. According to some embodiments, the clamp 104 may include two protrusions configured to apply pressure towards each other, such that when the tube 202/252/350 is positioned between the two protrusions, the pressure is applied onto the tube 202/252/350, thereby maintaining the position of the tube 202/252/350 fixed. According to some embodiments, and as described in greater detail elsewhere herein, the clamp 104 may include one or more springs coupled to the two protrusions. According to some embodiments, the one or more springs may be located between the protrusions and the housing 102. According to some embodiments, the springs may be configured for pressuring the protrusions of the clamp 104 towards each other.

Advantageously, a clamp that applies pressure onto the tube positioned therein enables the fixing of the position of the tube in relation to the housing regardless of the dimensions of the tube itself.

According to some embodiments, the clamp 104 is configured to secure the position of the tube 202/252/350 such that the plunger 204/256/357 of the tube 202/252/350 is positioned between the outlet end 208/258/365 of the tube 202/252/350 and the pusher 204.

According to some embodiments, the pusher may be slidably coupled to the housing 102. According to some embodiments, the pusher 108 may be configured to slide within the housing 102. According to some embodiments, the pusher 108 may be configured to slide through the opening 118 of the housing 102.

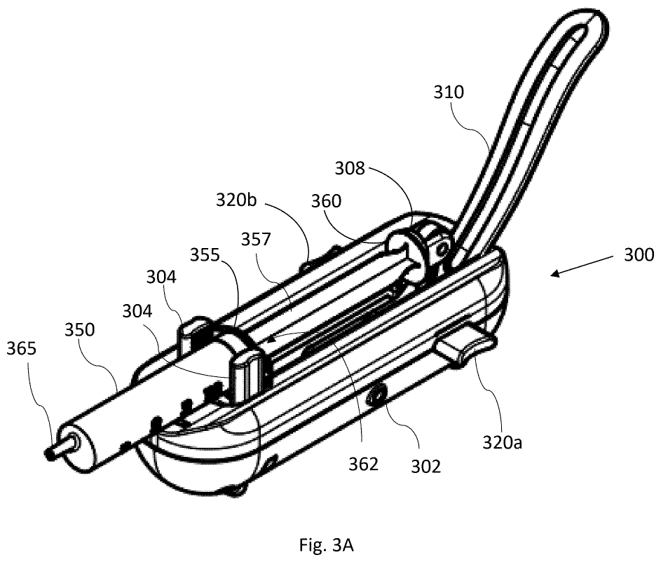

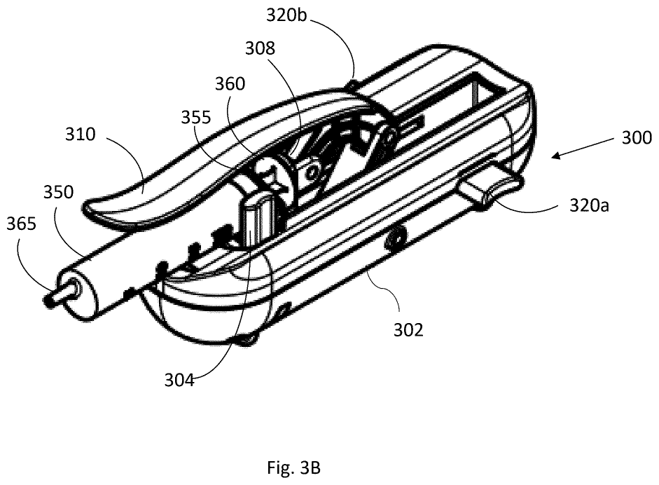

Reference is made to FIG. 3A and FIG. 3B, which show schematic illustrations of an aid device with a syringe, at an open configuration of the aid device and a closed configuration of the aid device, respectively, in accordance with some embodiments of the present invention.

According to some embodiments, the aid device 100/300 may be devoid of gears. Advantageously, an aid device devoid of gears prevents the incremental movement of the gears during rotation of. Accordingly, the aid device 100/300 provides rotational axes (such as, for example, the first axis of rotation, the second axis of rotation, and the third axis of rotation) configured to rotate continuously (and not incrementally).

According to some embodiments, the aid device 100/300 may be ergonomic, or in other words, may be designed to prevent physical discomfort. According to some embodiments, the aid device 100/300 as described herein enables the user to apply less force onto the aid device in order to empty a tube positioned within the aid device, than the amount of force that would be needed in order to push the plunger within the tube and empty the contents of the tube without the aid device 100/300.

According to some embodiments, the term “filled syringe” may include any tube, such as, for example, a syringe, that has, within its tube (or in other words, barrel), a substance intended for ejection from the syringe, such as a full syringe or a partially full syringe.

According to some embodiments, the tube may be inserted onto the housing 302/102 of the device 300/100, where the barrel 350 of the tube and/or syringe, is held by the clamp 304/104, and where a barrel flange 355 of the tube is positioned above the clamp 304/104. According to some embodiments, the clamp 304/104 may be configured to prevent the tube from moving by blocking the movement of the barrel flange 355 of the tube.

According to some embodiments, the aid device 300/100 may include one or more buttons 320a/320b (referred to hereinafter as buttons 320). According to some embodiments, the buttons 320 may be configured to be squeezed towards each other. According to some embodiments, the movement of the buttons 320 towards each other may be configured to open a gap between the two protrusions of the clamp 304/104, thereby enabling the insertion of the barrel 240 (or tube) between the protrusions of the clamp 304/104. According to some embodiments, the buttons 320 may be released for allowing the protrusions of the clamp 304/104 to close on the barrel 240 (or tube) and hold it in place. According to some embodiments, the clamp 304/104 may be opened to a gap of up to about 22 mm between the two protrusions. According to some embodiments, the clamp 304 may be opened to a gap of up to about 30 mm between the two protrusions. According to some embodiments, the clamp 304/104 may be opened to a gap of more than 6 mm between the two protrusions.

According to some embodiments, the plunger of the tube (or syringe) may include a plunger flange 360, which may be positioned under the pusher 308/108, of the device 300/100, when the lever 310/110 is in the open configuration. Thus, according to some embodiments, when the lever 310/110 is moved and pushed down, from the open configuration towards the closed configuration, as depicted in FIG. 3B for example, the lever 310/110 pushes the pusher 308/108 towards the clamp 304/104, which pushes the plunger flange 360 towards the barrel flange 355, effectively ejecting the contents of the syringe through a tip (or outlet end 208/258/365) thereof.

FIG. 3B shows an isometric diagram of a syringe in the aid device 300, after the syringe has been emptied, according to an embodiment of the invention. According to some embodiments, after the lever 310/110 has been pushed down, from the open configuration (such as depicted in FIG. 3A) into the closed configuration (such as depicted in FIG. 3B), the pusher 308/108 is moved closer to the clamp 304/104, and the plunger flange 360 is pushed towards the barrel flange 355. Thus, according to some embodiments, within the tube and/or barrel 350, the seal of the plunger 357/204 has also been pushed towards the tip (or outlet end 208/258/365) of the tube, thereby effectively ejecting the contents of the tube (or syringe) and emptying the tube (or syringe).

According to some embodiments, the lever 310/110 can also be pushed up, from the closed configuration to the open configuration, during which the pusher 308/108 is moved away from the clamp 304/104. According to some embodiments, after the lever 310/110 is pushed up, from the closed configuration to the open configuration, and the pusher 308/108 is moved away from the clamp 304/104, the buttons 320 may be squeezed together in order to open a gap between the two protrusions of the clamp 304/104. According to some embodiments, after the buttons 320 are squeezed together, the tube and/or syringe and/or barrel 350 may be extracted from the protrusions of the clamp 304/104, and thus the syringe is taken out of the device 300/100.

According to some embodiments, the aid device 100/300 may include one or more sensor configured to detect an amount of force applied to/by the pusher 108/308 and/or to the plunger. According to some embodiments, the one or more sensors may be coupled to the pusher via one or more springs.

According to some embodiments, the amount of force applied to the pusher may be converted to an amount of pressure applied onto the filter (or filter membrane) of the tube. According to some embodiments, the aid device 100/300 may include one or more buttons coupled to the aid device 100/300, the one or more buttons being configured communicate with the one or more sensors. According to some embodiments, the one or more buttons may be configured to set a limit to the movement of the pusher (or prevent a movement of the pusher at a predetermined amount of detected force). According to some embodiments, the one or more buttons may be set to a specific limit by the user. According to some embodiments, the one or more buttons may be set to a specific limit of the amount of force applied to/by the pusher 108/308 and/or to the plunger. According to some embodiments, the one or more buttons may communicate with the one or more sensors in real time, during operation of the aid device 100/300, such that when the one or more sensors detect a force that is above the predetermined limit inputted by the user, the one or more buttons may prevent the movement of the pusher and/or the plunger.

According to some embodiments, the one or more buttons may be configured to receive input from the user, the input being associated with a limit of the amount of force applied to the pusher and/or the plunger. According to some embodiments, the one or more buttons may be configured to receive input from the user, the input being associated with a limit of the amount of pressure applied to the filter (or filter membrane) coupled to the tube (or within the tube). According to some embodiments, the one or more buttons may be configured to convert the input of the user associated with the amount of pressure applied to the filter into an amount of force applied to the pusher and/or the plunger.

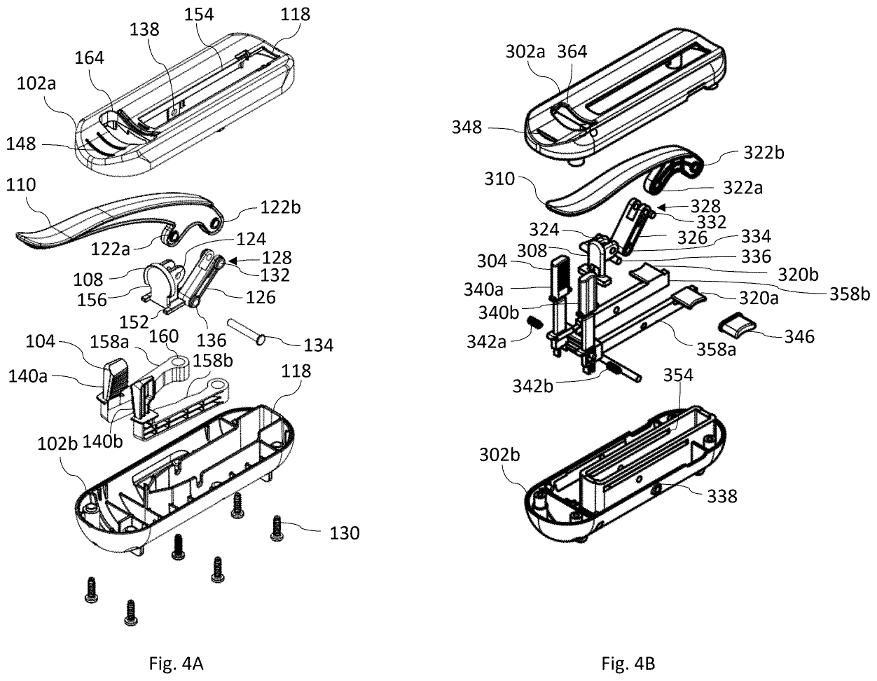

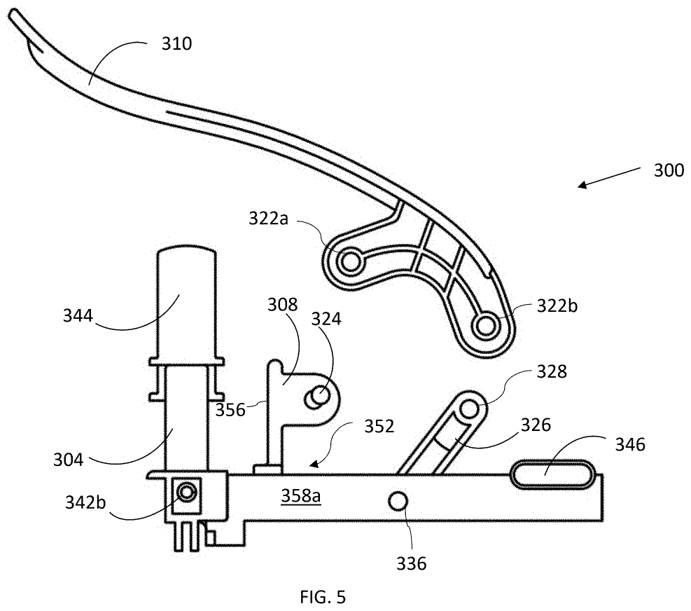

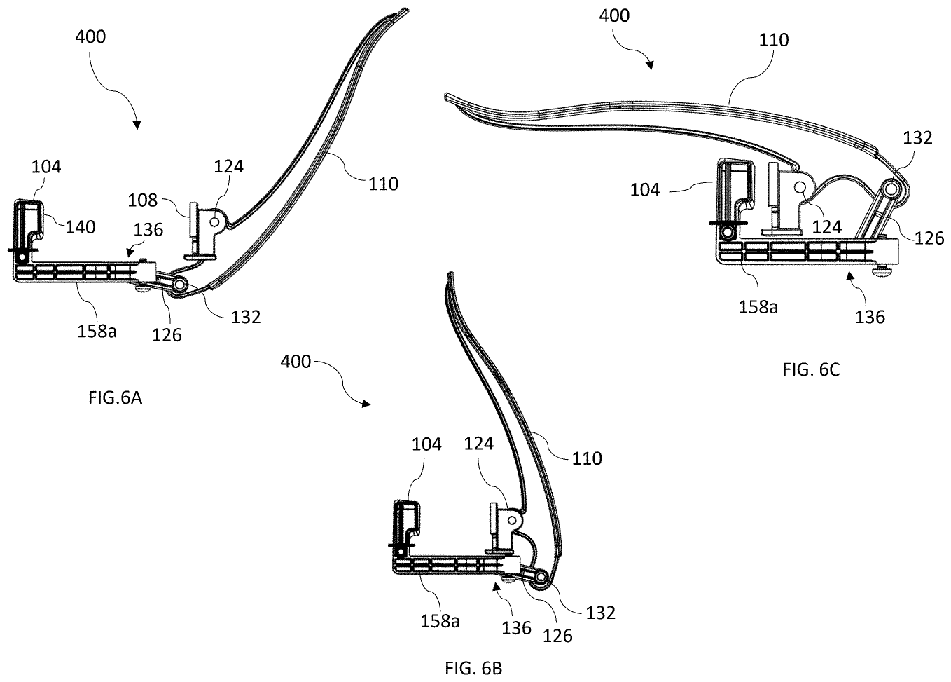

Reference is made to FIG. 4A and FIG. 4B, which show exploded schematic illustrations of exemplary aid devices, in accordance with some embodiments of the present invention, and to FIG. 5, which shows a schematic illustration of a portion of the aid device, in accordance with some embodiments of the present invention, and to FIG. 6A, FIG. 6B, and FIG. 6C, which show side view schematic illustrations of a portion of the aid device at an open configuration, a semi-closed configuration, and a closed configuration, respectively, in accordance with some embodiments of the present invention.

FIG. 4A and FIG. 4B depict some of the inner parts of the aid devices 100/300. According to some embodiments, the housing 302/102 of the aid device 100/300 may include an upper housing portion 102a/302a and a bottom housing portion 102b/302b. According to some embodiments, such as depicted in FIG. 4A, the upper housing portion 102a/302a and the bottom housing portion 102b/302b may be coupled and/or secured to each other. According to some embodiments, the upper housing portion 102a/302a and the bottom housing portion 102b/302b may be couple using screws, such as screw 130. According to some embodiments, the upper housing portion 102a/302a and the bottom housing portion 102b/302b maybe integral, other words, a unit (or inseparable). According to some embodiments, the bottom portion of the lever 310/110, or in other words, the portion of the lever 310/110 configured to couple to housing may be located inside the housing, while its upper portion of the lever 130/110 may be located outside the housing.

According to some embodiments, the bottom portion of the lever 310/110 may include holes 122a/122b/322a/322b configured to enable the coupling of the lever 310/110 to the housing 102/302 and/or the pusher 108/308. According to some embodiments, the front hole 122a/322a of the lever 310/110 may be pivotally connected to the pusher 308/108. According to some embodiments, the lever 310/110 may be coupled to the pusher 308/108 by a first axis of rotation 124/324. According to some embodiments, the lever 310/110 may be coupled to the pusher 308/108 by a first axis of rotation 124/324, such that the first axis of rotation 124/324 is positioned within the front hole 122a/322a. According to some embodiments, the first axis of rotation 124/324 may include a pin, a screw, a rivet, any other pivotal attaching means, and the like. According to some embodiments, the first axis of rotation 124/324 may include a bar or rod. According to some embodiments, the first axis of rotation 124/324 may be an integral portion of the pusher 308/108.

According to some embodiments, the pusher may include a bar or rod configured to be positioned through the front hole 122a/322a. According to some embodiments, the pusher 308/108 may include an opening configured to fit the first axis of rotation 124/324. According to some embodiments, the first axis of rotation 124/324 may include a bar, a rod, a pin, or the like, and may be configured to fit within the opening of the pusher 308/108 as well as the front hole 122a/322a of the lever 310/110, thereby enabling a rotation of the lever 310/110 in relation to the pusher 308/108. According to some embodiments, the first axis of rotation 124/324 may include a bar, a rod, a pin, or the like, and may be configured to fit within the opening of the pusher 308/108 as well as the front hole 122a/322a of the lever 310/110, thereby enabling a rotation of the pusher 308/108 in relation to the lever 310/110. According to some embodiments, the lever 310/110 may be configured to continuously rotate in relation to the pusher 308/108. According to some embodiments, the lever 310/110 may be configured to continuously rotate about the first axis of rotation 124/324.

According to some embodiments, the lever 310/110 may be pivotally connected to the housing 302/102. According to some embodiments, a rear hole 122b/322b of the lever 310/110 may be pivotally connected to the housing 302/102. According to some embodiments, the lever 310/110 may be coupled to the housing 302/102 by a second axis of rotation. According to some embodiments, the second axis of rotation is pivotally coupled to the housing 302/102. According to some embodiments, the lever 310/110 may be coupled to the housing 302/102 by at least two axes of rotation. According to some embodiments, the lever 310/110 may be coupled to the housing 302/102 by an auxiliary shaft 126/326 (or in other words, a second lever). According to some embodiments, the second axis of rotation may be pivotally coupled to the auxiliary shaft 126/326 (or in other words, the second lever). According to some embodiments, the auxiliary shaft 126/326 (or in other words, the second lever) may be pivotally coupled to the housing 302/102 by a third axis of rotation, thereby coupling the lever 310/110 to the housing via two axes of rotation.

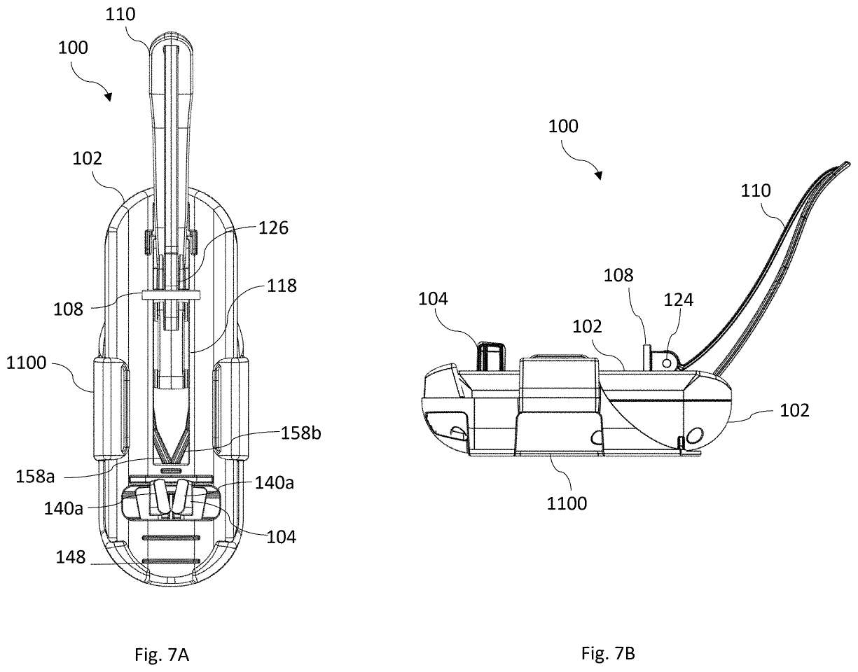

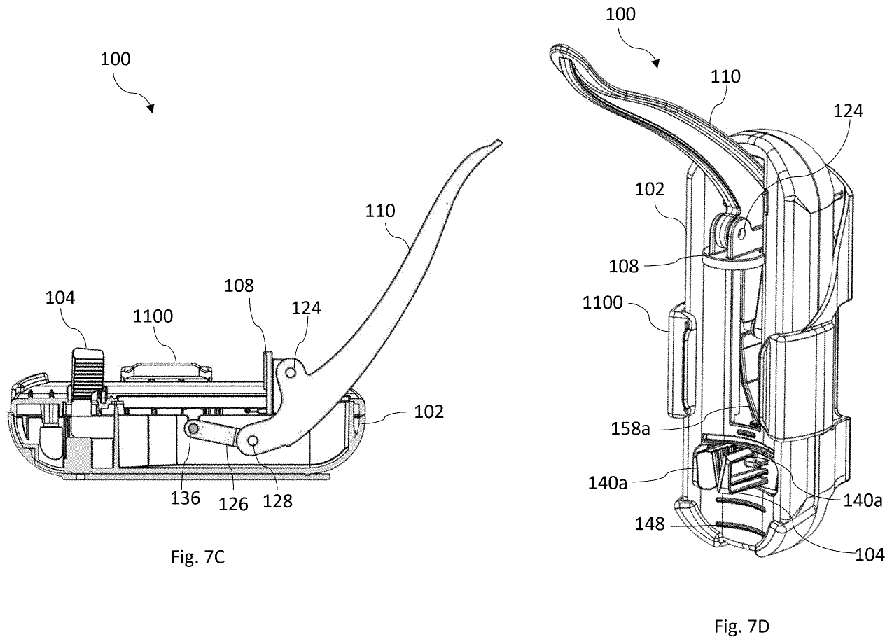

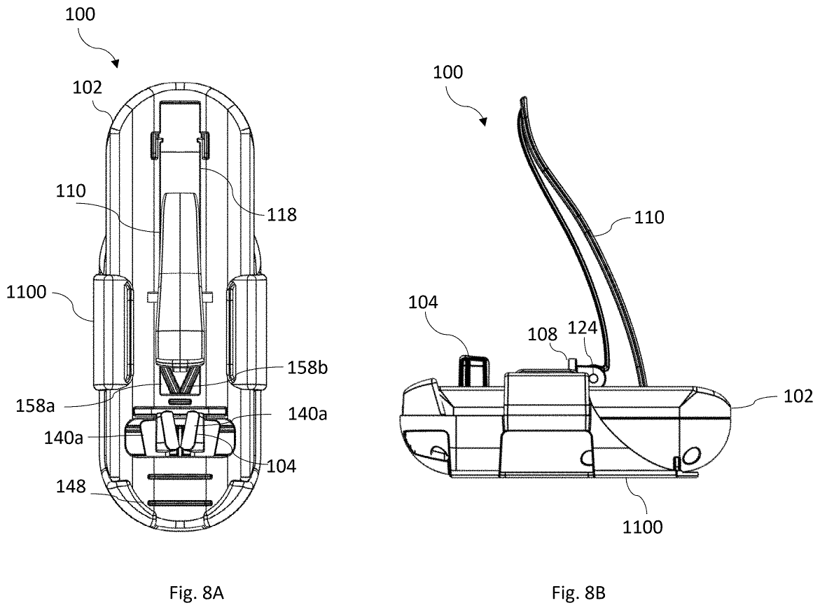

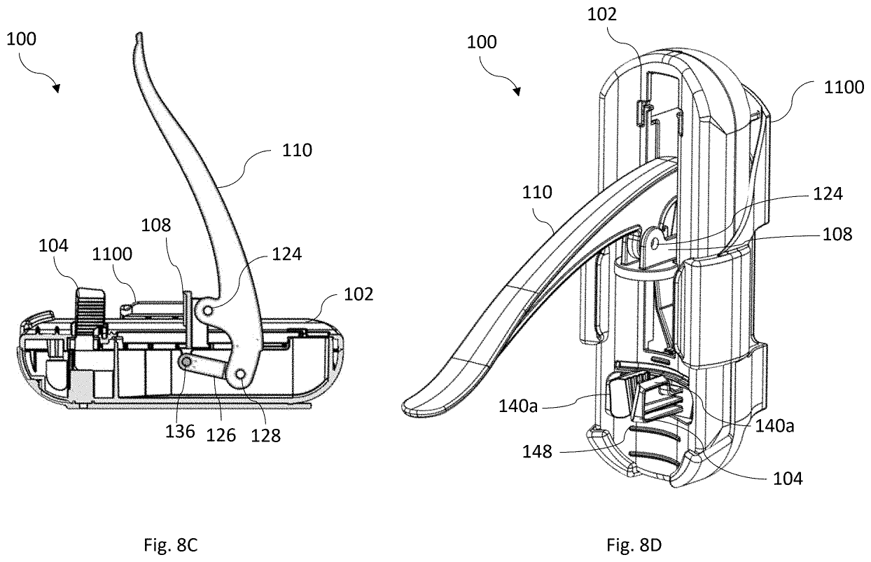

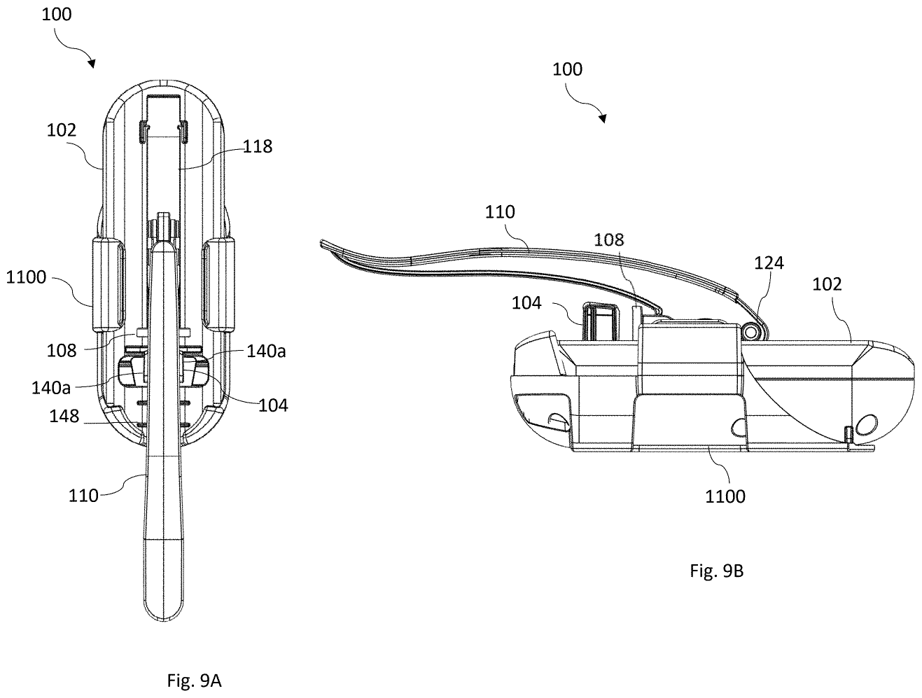

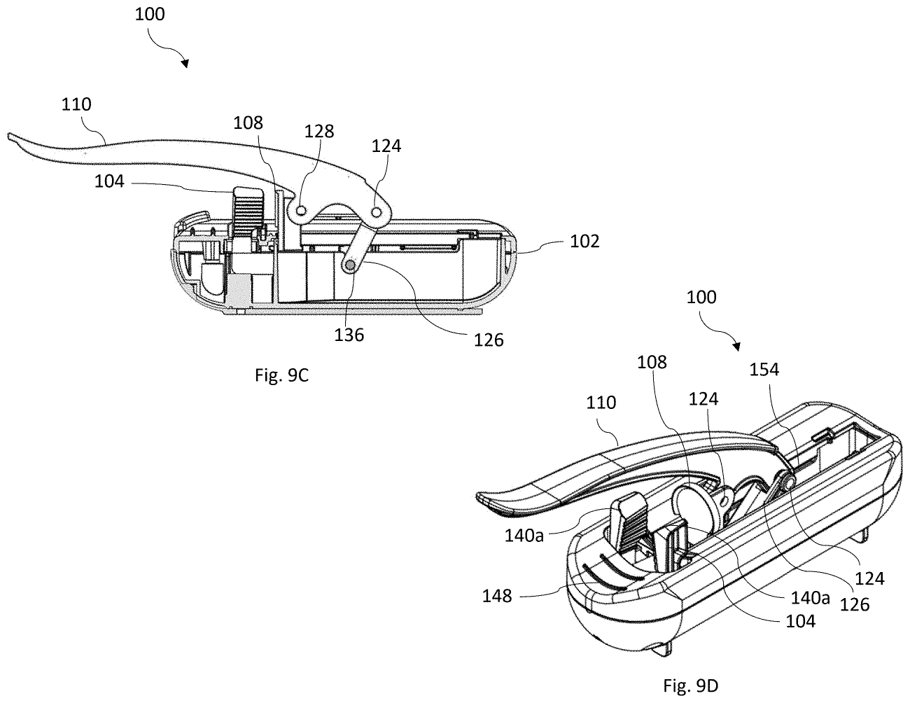

Reference is made to FIG. 7A, FIG. 7B, FIG. 7C, and FIG. 7D, which show top view, side view, cross sectional view, and perspective view schematic illustrations of an aid device at an open configuration thereof, in accordance with some embodiments of the present invention, to FIG. 8A, FIG. 8B, FIG. 8C, and FIG. 8D, which show top view, side view, cross sectional view, and perspective view schematic illustrations of an aid device at a semi-closed configuration thereof, in accordance with some embodiments of the present invention, and to FIG. 9A, FIG. 9B, FIG. 9C, and FIG. 9D, which show top view, side view, cross sectional view, and perspective view schematic illustrations of an aid device at a closed configuration thereof, in accordance with some embodiments of the present invention.

According to some embodiments, the rear hole 122b/322b of the lever 310/110 may be pivotally connected to a hole 128/328 of the auxiliary shaft 126/326 (or second lever). According to some embodiments, the lever 310/110 may be pivotally connected to the hole 128/328 of the auxiliary shaft 126/326 by the second axis of rotation 132/332. According to some embodiments, the second axis of rotation 132/332 may include a pin, a screw, a rivet, any other pivotal attaching means, and the like. According to some embodiments, the second axis of rotation 132/332 may include a bar or rod. According to some embodiments, the second axis of rotation 132/332 may be an integral portion of the auxiliary shaft 126/326 and/or the lever 310/110.

According to some embodiments, the auxiliary shaft 126/326 may include a bar or rod configured to be positioned through the rear hole 122b/322b. According to some embodiments, the hole 128/328 of the auxiliary shaft 126/326 may be configured to fit the second axis of rotation 132/332. According to some embodiments, the second axis of rotation 132/332 may include a bar, a rod, a pin, or the like, and may be configured to fit within the hole 128/328 of the auxiliary shaft 126/326 as well as the rear hole 122b/322b of the lever 310/110, thereby enabling a rotation of the lever 310/110 in relation to the auxiliary shaft 126/326. According to some embodiments, the second axis of rotation 132/332 may include a bar, a rod, a pin, or the like, and may be configured to fit within the opening of the auxiliary shaft 126/326 as well as the rear hole 122b/322b of the lever 310/110, thereby enabling a rotation of the auxiliary shaft 126/326 in relation to the lever 310/110. According to some embodiments, the lever 310/110 may be configured to continuously rotate in relation to the auxiliary shaft 126/326. According to some embodiments, the lever 310/110 may be configured to continuously rotate about the second axis of rotation 124/324.

According to some embodiments, the auxiliary shaft 126/326 may be pivotally connected to the housing 102/302. According to some embodiments, the auxiliary shaft 126/326 may be pivotally connected to the bottom housing portion 102b/302b. According to some embodiments, the auxiliary shaft 126/326 may be pivotally connected to the housing 102/302 and/or the bottom housing portion 102b/302b by a third axis of rotation 136/336. According to some embodiments, the auxiliary shaft 126/326 may be pivotally connected to the housing 102/302 by third axis of rotation 136/336 or any other pivotal attaching means such as a screw or rivet, etc. According to some embodiments, the auxiliary shaft 126/326 may include an opening 134/334 configured to receive the third axis of rotation 136/336. According to some embodiments, the housing 102/302 may include an opening 138/338 configured to receive the third axis of rotation 136/336. According to some embodiments, such as depicted in FIG. 4A, the upper housing portion 102a may include the opening 138 configured to receive the third axis of rotation 136. According to some embodiments, such as depicted in FIG. 4B, the bottom housing portion 302b may include the opening 338 configured to receive the third axis of rotation 336.

According to some embodiments, the third axis of rotation 136/336 may include a bar, a rod, a pin, or the like, and may be configured to fit within the hole 128/328 of the auxiliary shaft 126/326 as well as the opening 138/338 of the housing 102/302, thereby enabling a rotation of the auxiliary shaft 126/326 in relation to the housing 102/302. According to some embodiments, the auxiliary shaft 126/326 (or second lever) may be pivotally connected to the housing 102/302 at a first end of the auxiliary shaft 126/326 (or second lever), and pivotally connected to the lever 310/110 at a second end of the auxiliary shaft 126/326 (or second lever).

According to some embodiments, the opening 118/318 may extend through the upper housing portion 102a and/or the bottom housing portion 302b. According to some embodiments, the opening 118/318 may be configured to receive any one or more of the lever 310/110, the auxiliary shaft 126/326 (or second lever), the first axis of rotation 124/324, the second axis of rotation 124/324, and the pusher 308/108. According to some embodiments, any one or more of the lever 310/110, the auxiliary shaft 126/326 (or second lever), the first axis of rotation 124/324, the second axis of rotation 124/324, and the pusher 308/108 may be moveable and/or slidable within the opening 118/318.

According to some embodiments, when the lever 310/110 is lowered, the front side of the bottom part of the lever 310/110 pushes the pusher 308/108 forwards towards the clamp 304/104 in the front of the aid device, while the rear side of the bottom part of the lever 310/110 (or in other words, the portion of the lever 310/110 that is coupled to the housing 302/102) is movably connected by the auxiliary shaft 126/326 to the bottom housing portion 102b/302b of the aid device 100/300.

According to some embodiments, the lever is rotatable about two axes of rotation simultaneously. According to some embodiments, the lever is rotatable about the first axis of rotation 124/324 and about the second axis of rotation 132/332 simultaneously.

According to some embodiments, the clamp 304/104, may include two protrusions 140a/140b/340a/340b (collectively referred to herein as protrusion 140/340). According to some embodiments, the device 100/300 may include springs or any other tension means, between the protrusions 140/340 and the housing 102/302 for pressuring the protrusions 140/340 towards each other. For example, according to some embodiments, the device 100/300 may include springs 342a/342b between the protrusions 140/340 and the housing 102/302 for pressuring the protrusions 140/340 towards each other. According to some embodiments, other options for pressuring the protrusions towards each other may be used as known in the art. According to some embodiments, the buttons 320 may be physically connected to protrusions 140/340. According to some embodiments, the buttons 320 may be coupled to protrusions 140/340 such that pressing the buttons 320 together separates the protrusions 140/340 (or in other words, generates a gap between the two protrusions 140/340) thereby moving the protrusions 140/340 away from each other. Other options for moving the protrusions away from each other may be used, as known in the art.

According to some embodiments, the protrusions 140/340 may be separated (or pulled away from each other) by a user. According to some embodiments, once the buttons 320 are pushed and squeezed together, the two protrusions 140/340 are moved away from each other, and the tube (or barrel of a syringe) can be inserted between the protrusions 140/340, after which the buttons 320 may be released for allowing the protrusions 140/340 of the clamp 304/104 to close on the tube (or barrel of a syringe) and hold the tube (or, for example, the barrel of the syringe) for preventing the tube (or barrel) from moving. According to some embodiments, the buttons 320 may be protruding from the housing 102/302. According to some embodiments, the buttons 320 may be protruding from the housing through an opening along the housing 102/302.

According to some embodiments, the buttons 320 may be located at the sides of the rear part of the aid device 100/300 and/or housing 102/302. According to some embodiments, each of the buttons 320 may be located at either side of the housing 102/302. According to some embodiments, the buttons 320 may be located at the sides of the front part of the aid device 100/300 and/or housing 102/302.

FIG. 5 is a right side view illustration of some of the inner parts of the aid device 100/300, according to an embodiments of the invention. FIG. 5 depicts the aid device in a closed configuration thereof, similar to FIG. 2 and FIG. 3B, however, in this diagram the inner parts are depicted without at least a portion of the housing 102/302. FIG. 6A, FIG. 6B, and FIG. 6C depict some of the inner parts of the aid device, without at least a portion of the housing 102/302, at an open configuration, a semi-closed configuration, and a closed configuration of the aid device 100/300, respectively.

According to some embodiments, the protrusions 140/340 of clamp 304/104 may include caps, such as cap 344. According to some embodiments, the caps may be made of rubber or any other material configured to better hold (or grip) the tube (or barrel of a syringe). According to some embodiments, the buttons 320 may include caps, such as, for example, cap 346. According to some embodiments, the caps may be made of rubber or any other material designed to better suit a human hand.

According to some embodiments, in order to operate the device 100/300 with a filled tube, the tube is first inserted onto the housing 102/302, by inserting the tube barrel into the clamp 304/104 of the aid device 100/300, while the lever 110/310 is in the open configuration. According to some embodiments, when the tube is held by the clamp 304/104 while the plunger flange 220/360 is located between the pusher 308/108 and the clamp 304/104, the lever 310/110 of the device 100/300 may be moved, from the open configuration to the closed configuration. According to some embodiments, when the lever 310/110 is closed (and moved from the open configuration to the closed configuration), the lever 310/110 pushes the pusher 308/108 towards the clamp 304/104, thereby emptying the contents of the tube, by pushing the plunger flange 220/360 within towards the tube (or in other words, pushing the plunger within the tube). According to some embodiments, the movement of the lever 110/310 from the open configuration to the closed configuration may provide an ergonomic aid in emptying the tube, which may enable the user to move the lever 110/310 from an open configuration to a closed configuration using pressure between two hands of the user, or between a hand and an arm of the user, instead of the using of the pressure force between the thumb to fingers (as used to empty the content of the tube or syringe without the aid device).

According to some embodiments, the operator (or user) may move the lever 110/310 of the device 100/300 only partially from the open configuration to a semi-closed configuration, as to only partially empty the contents of the tube. According to some embodiments, the lever 110/310 may be transparent, thereby enabling the operator to see how much of the content of the syringe is emptied. According to some embodiments, the lever 110/310 may be transparent and may be composed or a material configured to magnify, thereby enabling the operator to see how much of the content of the tube is emptied.

According to some embodiments, the device 100/300 may also be used to fill a tube (or a syringe). According to some embodiments, the pusher 308/108 of the device 100/300 may have one or more cavities or slots, or any other means, for holding the plunger's flange (such as, for example, the one or more slots 148/348). According to some embodiments, when the plunger flange is held by the pusher 308/108 and the lever 110/310 is moved from the closed configuration to the open configuration, the lever 110/310 pulls the pusher 308/108 away from the clamp 104/304, which pulls the plunger's flange away from the barrel flange, thereby effectively allowing the filling of the tube and/or syringe through a tip or outlet end thereof.

According to some embodiments, the pusher 108/308 may include a plate 156/356 configured to abut the plunger and/or the plunger flange. According to some embodiments, the plate 156/356 may include a clamp configured to secure the plunger and/or the plunger flange to the plate 156/356 and/or to the plusher 108/308. According to some embodiments, the pusher 108/308 may include a base 152/352 configured to slide within the housing 102/302. According to some embodiments, the base 152/352 may be coupled to the plate 156/356. According to some embodiments, the base 152/352 may extend from the plate 156/356. According to some embodiments, the base 152/352 and the plate 156/356 may be an integral unit. According to some embodiments, the base 152/352 may be configured to slide along a rail. According to some embodiments, the base 152/352 may be configured to slide along a rail 154/354 of the housing 102/302. According to some embodiments, the pusher 108/308 may be slidably coupled to the housing 102/302 via the rail 154/354.

According to some embodiments, the rail 154/354 may be a slot within a portion of the housing 102/302. According to some embodiments, the rail 154/354 may extend parallel to the opening 118/318 of the housing 102/302, such that movement of the pusher 108/308 within the rail 154/354 corresponds to movement of the pusher 108/308 within the opening 118/318. According to some embodiments, such as depicted in FIG. 4A, the rail 154 may be located along a portion of the upper housing portion 102a. According to some embodiments, such as depicted in FIG. 4B, the rail 354 may be located along a portion of the bottom housing portion 302b. According to some embodiments, the pusher 108/308 may slidably coupled to the rail 154/354 such that rotation of the lever 110/310 initiates movement of the pusher 108/301 along the rail 154/354.

According to some embodiments, the clamp 104/304 may be coupled to the housing 102/302. According to some embodiments, the clamp 104/304 may be coupled to the housing via one or more arms 158a/158b/358a/358b (collectively referred to herein as arms 158/358). According to some embodiments, the one or more arms 158/358 may include an elongated element, such as a rod. According to some embodiments, each of the one or more arms 158/358 may extend from one of the protrusions 140/340. According to some embodiments, each of the one or more arms may be configured to apply pressure to the one or more protrusions 140/340. According to some embodiments, the springs of the aid device may be configured to apply pressure to the protrusion 140/340 by applying pressure to the one or more arms 158/358. According to some embodiments, each protrusion 140a/140b/340a/340b may be coupled to and/or may extend from an arm 158a/158b/358a/358b.

According to some embodiments, such as depicted in FIG. 4A, the arms 158a/158b may be coupled to the housing 102. According to some embodiments, the arms 158a/158b may be pivotally coupled to the housing 102 via a fourth axis of rotation 160. According to some embodiments, such as depicted in FIG. 4B, the arms 358a/358b may be coupled from (and/or extending from) the buttons 320a/320b, such that movement of the buttons 320 may move the protrusion 340 via the movement of the arms 358.

According to some embodiments, the protrusions 140/340 may extend from within the housing 102/302 and outwards from the housing 102/302 through one or more openings 164/364. According to some embodiments, the one or more openings 164/364 may be positioned along the upper housing portion 102a/302a. According to some embodiments, the one or more openings 164/364 may be configured to enable movement of the clamps 104/304 and/or the productions 140/340 therein. According to some embodiments, the one or more openings 164/364 may be (essentially) adjacent to the opening 118/318, thereby preventing movement of the tube in a direction parallel to a longitudinal axis of the opening 118/318.

Advantageously, according to some embodiments, the aid device may be used to eject content from the tube and/or the syringe. According to some embodiments, the aid device may be used to take in content, into the tube and/or syringe (or in other words, fill the tube and/or syringe up). According to some embodiments, the aid device may be used with a tube or syringe which is coupled to a filter, such that content exiting the tube and/or syringe is filtered during the ejection of the content. According to some embodiments, the aid device may be used with a tube or syringe which is coupled to a filter, such that content that is taken into the tube and/or syringe is filtered during the filling of the tube and/or the syringe.

According to some embodiments, for a tube and/or syringe that is coupled to a filter at an outlet end of the tube and/or filter, the aid device may enable the user to fill up the tube and/or syringe with content such that the content is first filtered through the filter and then enters the barrel of the tube and/or the syringe.

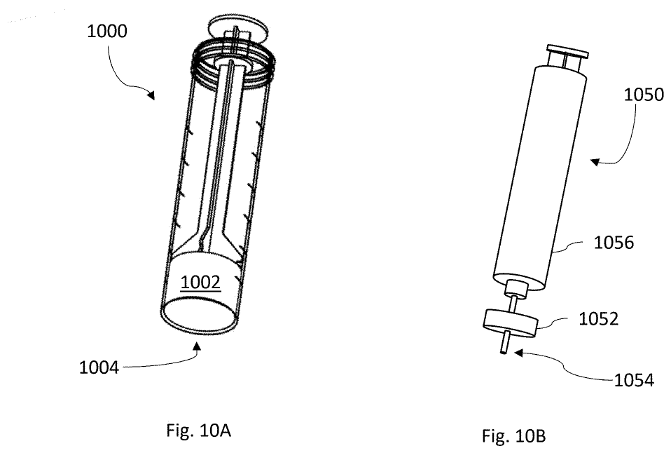

Reference is made to FIG. 10A and FIG. 10B, which show exemplary tubes for use with an aid device, in accordance with some embodiments of the present invention.

According to some embodiments, the aid device 100/300 may be configured to secure a tube thereto. According to some embodiments, the aid device 100/300 may be configured to aid emptying the contents of the tube in an ergonomic manner. According to some embodiments, the aid device may be configured to receive a variety of tube types, such as, for example, any one or more filtering tubes, syringes, and the like. According to some embodiments, such as depicted in FIG. 10A, the tube 1000 may include a filter 1002. According to some embodiments, the filter 1002 may be positioned within the tube 1000. According to some embodiments, the filter 1002 may be coupled to an outlet end 1004 of the tube 1000 (which may correspond to outlet end 285 of the tube 252 depicted in FIG. 1B). According to some embodiments, such as depicted in FIG. 10B, the tube 1050 may be a syringe. According to some embodiments, the tube 1050 may include a filter 1052. According to some embodiments, the filter 1052 may be coupled to the tube 1050. According to some embodiments, the filter 1052 may be coupled to the outlet end 1054 of the tube 1050 (such as, for example, a needle hub of a syringe, or the like). According to some embodiments, the filter 1052 may be positioned such that content exiting a barrel 1056 of the tube 1050 may be filtered through the filter 1052 during the ejection. According to some embodiments, the filter 1052 may be positioned such that content being taken into the barrel 1056 of the tube 1050 may be filtered before entering the barrel 1056 of the tube, thereby filling the barrel 1056 of the tube 1050 with filtered content.

Advantageously, an aid device with a lever 110/310 rotating about at least one axis of rotation enables the continuous emptying (or filling) of the content of the tube. According to some embodiments, the aid device may enable continuous insertion of content into the tube, such as depicted in greater detail elsewhere herein.

Advantageously, an aid device with a lever 110/310 rotating about at least one axis of rotation enables a user to empty and/or insert the content of the tube in an ergonomic manner, or in other words, without needing to apply the same amount of force to the plunger, in relation to emptying and/or inserting the content of the tube without the aid device. According to some embodiments, the lever 110/310 may be implemented within the aid device 100/300 to reduce the amount of force applied by the user (in other to empty the tube). Advantageously, this may enable the user to empty content through a filter of a tube easily. Moreover, for content that may be viscous, or non-Newtonian, fluid, the aid device 100/300 may enable a user to effortlessly control the amount of content that is emptied and/or inserted to the tube.

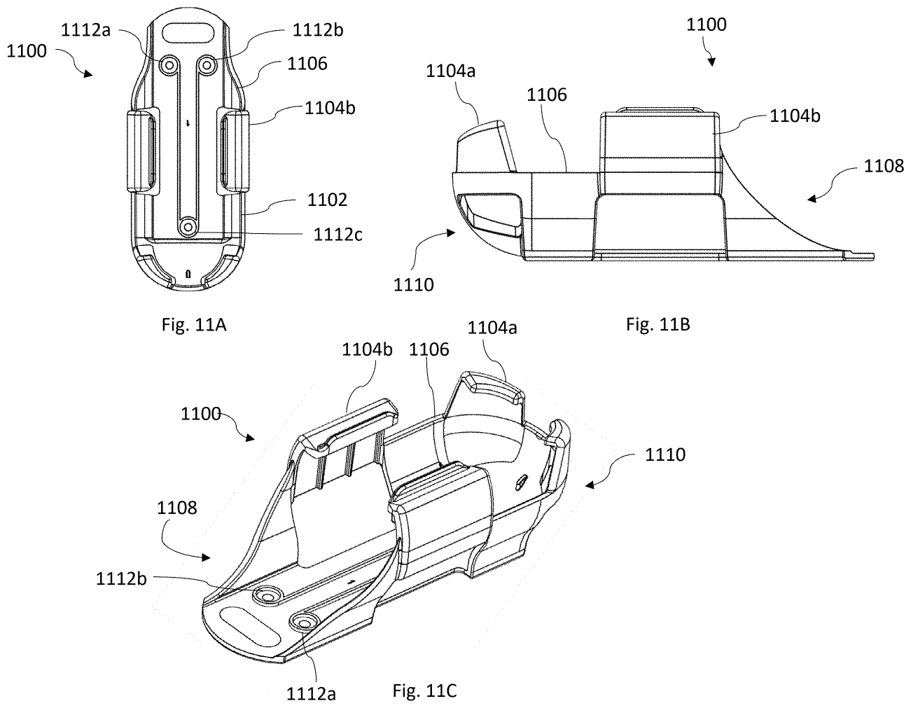

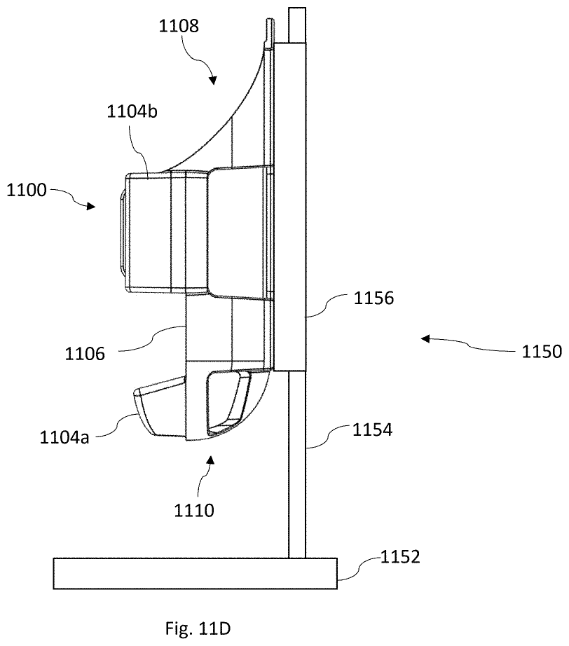

Reference is made to FIG. 11A, FIG. 11B, and FIG. 11C are top view, side view, and perspective view schematic illustrations of an anchoring device for the aid device, in accordance with some embodiments of the present invention.

According to some embodiments, the aid device 100/300 may include an anchoring device 1100 configured to anchor the aid device 100/300 to a surface, such as, for example, a wall or a table. According to some embodiments, the anchoring device 1100 may be configured to anchor the aid device to a stand, such as described in greater detail elsewhere herein. According to some embodiments, the anchoring device 1100 may be configured to hold and/or secure the position of the aid device 100/300. According to some embodiments, the anchoring device 1100 may include a body 1102 configured to surround and/or enclose at least a portion of the housing 102/302 of the aid device 100/300. According to some embodiments, the anchor device 1100 may include one or more shoulders 1104a/1104b configured to maintain the position of the housing 102/302 fixed in relation to the anchoring device 1100. According to some embodiments, the one or more shoulder 1104a/1104b may be positioned around a rim 1106 of the body 1102 of the anchoring device 1100. According to some embodiments, the anchoring device 1100 may include an opening 1108 configured to enable the insertion of the housing 102/302 and/or the aid device 100/300 therethrough.

According to some embodiments, the opening 1108 may be positioned at a location such that when the aid device 100/300 is positioned/secured within the anchoring device 1100, the distal end 114 of the aid device 100/300 is positioned within the opening 1108. According to some embodiments, the anchoring device 1100 may include a wall 1110 configured to prevent the movement of the aid device 100/300. According to some embodiments, the wall 1110 may be positioned such that when the aid device 100/300 is positioned/secured within the anchoring device 1100, the proximal end 116 of the aid device 100/300 is abutting an inner surface of the wall 1110 of the anchoring device 1100. According to some embodiments, the anchoring device 1100 may include one or more openings 1112a/1112b/1112c configured to aid the securing of the anchoring device 1100 to a surface, for example, by positioning one or more nails and/or screws therethrough.

Advantageously, an anchoring device may enable a user to operate the aid device using only one hand.

Reference is made to FIG. 11D, which shows a side view schematic illustration of an anchoring device for the aid device coupled to a stand, in accordance with some embodiments of the present invention.

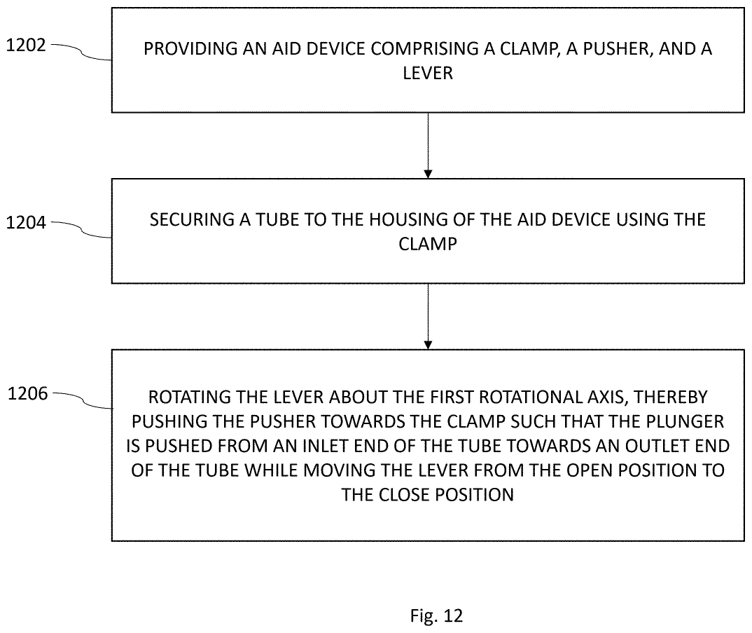

According to some embodiments, the anchoring device 1100 may be coupled to a stand 1150 configured to support the anchoring device 1100. According to some embodiments, the stand may include a base 1152 configured to be placed onto a surface, such as, for example, a table. According to some embodiments, the stand 1150 may include an elongated portion 1154 coupled to the base 1152. According to some embodiments, the elongated portion 1154 may include a rod and/or a plate. According to some embodiments, the stand 1150 may include a sliding portion 1156 configured to couple to the anchoring device 1100 and/or the aid device 100/300. According to some embodiments, the sliding portion 1156 may be configured to fix the orientation and/or the position of the anchoring device 1100 and/or the aid device 100/300 in relation to the sliding portion 1156. According to some embodiments, the sliding portion 1156 may be configured to slide about the elongated portion 1154. According to some embodiments, the sliding portion 1156 may include a locking mechanism for locking (and/or unlocking) a position of the sliding portion 1156 in relation to the elongated portion 1154. According to some embodiments, the sliding portion 1156 may be configured to slide about the elongated portion 1154 when the locking mechanism is at an unlocked state. Reference is made to FIG. 12, which shows a flow chart of steps of a method for emptying contents of a tube using an aid device, in accordance with some embodiments of the present invention.

According to some embodiments, at step 1202, the method may include providing an aid device including a clamp, a pusher, and a lever. According to some embodiments, the method may include providing an aid device 100/300 including a housing, such as the housing 102/302. According to some embodiments, the method may include providing an aid device 100/300 including a clamp coupled to the housing and configured to secure a position of the tube in relation to the housing. According to some embodiments, the method may include providing an aid device 100/300 including a clamp, such as, for example, the clamp 104/304. According to some embodiments, the method may include providing an aid device 100/300 including a pusher configured to abut the plunger, such as, for example, pusher 108/308. According to some embodiments, the method may include providing an aid device 100/300 including a lever pivotally coupled to the pusher by a first rotational axis such that the lever is continuously rotatable between an open configuration and a closed configuration about the first rotational axis, such as, for example lever 110/310. According to some embodiments, at step 1204, the method may include securing a tube to the housing using the clamp. According to some embodiments, the tube may include a syringe. According to some embodiments, and as described in greater detail elsewhere herein, the tube may include and/or may be coupled to a filter. According to some embodiments, at step 1206 the method may include rotating the lever about the first rotational axis, thereby pushing the pusher towards the clamp such that the plunger is pushed from an inlet end of the tube towards an outlet end of the tube while moving the lever from the open configuration to the closed configuration.

According to some embodiments, the lever may be pivotally coupled to the housing by the second axis of rotation, such that moving the lever from the open configuration to the closed configuration includes rotating the lever about the second axis of rotation. According to some embodiments, the second axis of rotation may be pivotally coupled to a second lever (or auxiliary shaft). According to some embodiments, the second lever (or auxiliary shaft) may pivotally coupled to the housing by the third axis of rotation, such that moving the lever from the open configuration to the closed configuration may include rotating the lever about the first axis of rotation and/or about the second axis of rotation. According to some embodiments, moving the lever from the open configuration to the closed configuration may include rotating the second lever (or auxiliary shaft) about the third axis of rotation. According to some embodiments, moving the lever from the open configuration to the closed configuration may include sliding the pusher along/within the rail.

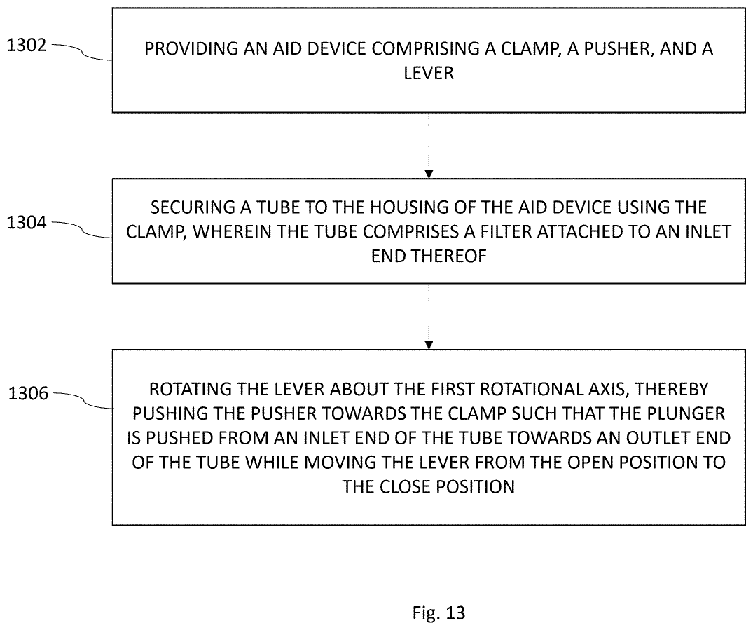

Reference is made to FIG. 13, which shows a flow chart of steps of a method for filtering a substance through a tube using an aid device, in accordance with some embodiments of the present invention.

According to some embodiments, at step 1302, the method may include providing an aid device including a clamp, a pusher, and a lever. According to some embodiments, the method may include providing an aid device 100/300 including a housing, such as the housing 102/302. According to some embodiments, the method may include providing an aid device 100/300 including a clamp coupled to the housing and configured to secure a position of the tube in relation to the housing. According to some embodiments, the method may include providing an aid device 100/300 including a clamp, such as, for example, the clamp 104/304. According to some embodiments, the method may include providing an aid device 100/300 including a pusher configured to abut the plunger, such as, for example, pusher 108/308. According to some embodiments, the method may include providing an aid device 100/300 including a lever pivotally coupled to the pusher by a first rotational axis such that the lever is continuously rotatable between an open configuration and a closed configuration about the first rotational axis, such as, for example lever 110/310. According to some embodiments, at step 1304, the method may include securing a tube to the housing using the clamp 104/304. According to some embodiments, the tube may include a filter attached to an end thereof. According to some embodiments, the tube may include a filter attached to an outlet end thereof, such that content exiting the tube is ejected through the filter. According to some embodiments, the tube may be coupled to a filter at an end thereof, such that content exiting the tube is ejected through the filter.

According to some embodiments, the tube may include a syringe. According to some embodiments, and as described in greater detail elsewhere herein, the tube may include and/or may be coupled to a filter. According to some embodiments, at step 1306 the method may include rotating the lever 110/310 about the first rotational axis 124/324, thereby pushing the pusher 108/308 towards the clamp 104/304 such that the plunger is pushed from an inlet end of the tube towards an outlet end of the tube, while moving the lever 110/310 from the open configuration to the close configuration. According to some embodiments, the method may include filtering the content exiting the outlet end of the tube using the filter coupled to the tube. According to some embodiments, the method may include filtering the content of the tube by pushing the plunger into the tube using the lever and/or pusher as described herein.

According to some embodiments, the lever 110/310 may be pivotally coupled to the housing by the second axis of rotation, such that moving the lever from the open configuration to the closed configuration includes rotating the lever 110/310 about the second axis of rotation. According to some embodiments, the second axis of rotation may be pivotally coupled to a second lever (or auxiliary shaft). According to some embodiments, the second lever (or auxiliary shaft) may pivotally coupled to the housing by the third axis of rotation, such that moving the lever 110/310 from the open configuration to the closed configuration may include rotating the lever 110/310 about the first axis of rotation and/or about the second axis of rotation. According to some embodiments, moving the lever 110/310 from the open configuration to the close configuration may include rotating the second lever (or auxiliary shaft) about the third axis of rotation. According to some embodiments, moving the lever 110/310 from the open configuration to the close configuration may include sliding the pusher 108/308 along/within the rail 154/354.

While the above description discloses many embodiments and specifications of the invention, these were described by way of illustration and should not be construed as limitations on the scope of the invention. The described invention may be carried into practice with many modifications which are within the scope of the appended claims.

In the description and claims of the application, the words “include” and “have”, and forms thereof, are not limited to members in a list with which the words may be associated.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although stages of methods according to some embodiments may be described in a specific sequence, methods of the disclosure may include some or all of the described stages carried out in a different order. A method of the disclosure may include a few of the stages described or all of the stages described. No particular stage in a disclosed method is to be considered an essential stage of that method, unless explicitly specified as such.

Although the disclosure is described in conjunction with specific embodiments thereof, it is evident that numerous alternatives, modifications and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the disclosure. Section headings are used herein to ease understanding of the specification and should not be construed as necessarily limiting.

1. An aid device, for manually emptying contents of a tube, comprising:
a housing;
a clamp, coupled to the housing and configured to secure a position of the tube in relation to the housing, wherein the tube comprises a plunger configured to slide within the tube between an inlet end of the tube and an outlet end of the tube;
a pusher configured to abut the plunger; and
a lever pivotally coupled to the pusher by a first rotational axis such that the lever is continuously rotatable between an open configuration and a closed configuration about the first rotational axis, thereby facilitating a continuous movement of the pusher from the open configuration to the closed configuration;
wherein the clamp is configured to secure the position of the tube such that the plunger of the tube is positioned between the outlet end of the tube and the pusher.

2. The device according to claim 1, wherein the lever is pivotally coupled to the housing by a second axis of rotation.

3. The device according to claim 2, wherein the second axis of rotation is pivotally coupled to a second lever.

4. The device according to claim 3, wherein the second lever is pivotally coupled to the housing by a third axis of rotation.

5. The device according to any one of claim 1, wherein said tube comprises a filter attached to an end thereof.

6. The device according to any one of claim 1, wherein the housing further comprises a rail, and the pusher is slidably coupled to the rail such that rotation of the lever initiates movement of the pusher within the rail.

7. The device according to any one of claim 1, wherein the aid device is devoid of gears.

8. The device according to any one of claim 1, wherein the clamp comprises two protrusions for holding the tube.

9. The device according to claim 8, further comprising springs located between the protrusions and the housing, the springs being configured for pressuring the protrusions towards each other.

10. The device according to any one of claim 1, wherein the aid device is ergonomic.

11. The device according to any one of claim 1, wherein the device further comprises at least one sensor configured to detect an amount of force applied to/by the pusher and/or to the plunger, and one or more buttons in communication with the one or more sensors and coupled to the pusher, and wherein for a predetermined amount of force, the buttons are configured to prevent movement of the pusher.

12. Method for emptying contents of a tube, the method comprising:
providing an aid device comprising:
a housing;
a clamp coupled to the housing and configured to secure a position of the tube in relation to the housing;
a pusher configured to abut the plunger; and
a lever pivotally coupled to the pusher by a first rotational axis such that the lever is continuously rotatable between an open configuration and a closed configuration about the first rotational axis, thereby facilitating a continuous movement of the pusher from the open configuration to the closed configuration;
securing a tube to the housing using the clamp; and
rotating the lever about the first rotational axis, thereby pushing the pusher towards the clamp such that the plunger is pushed from an inlet end of the tube towards an outlet end of the tube while moving the lever from the open configuration to the closed configuration.

13. The method of claim 12, wherein the lever is pivotally coupled to the housing by a second axis of rotation, and wherein moving the lever from the open configuration to the closed configuration comprises rotating the lever about the second axis of rotation.

14. The method of any one of claim 12, wherein the second axis of rotation is pivotally coupled to a second lever and the second lever is pivotally coupled to the housing by a third axis of rotation, and wherein moving the lever from the open configuration to the closed configuration comprises rotating the lever about the first axis of rotation and/or about the second axis of rotation.

15. The method of claim 14, wherein moving the lever from the open configuration to the closed configuration comprises rotating the second lever about the third axis of rotation.

16. The method of any one of claim 12, wherein the housing further comprises a rail, and wherein moving the lever from the open configuration to the closed configuration sliding the pusher along the rail.

17. Method for filtering a substance through a tube, the method comprising:
providing an aid device comprising:
a housing;
a clamp coupled to the housing and configured to secure a position of the tube in relation to the housing;
a pusher configured to abut the plunger; and
a lever pivotally coupled to the pusher by a first rotational axis such that the lever is continuously rotatable between an open configuration and a closed configuration about the first rotational axis, thereby facilitating a continuous movement of the pusher from the open configuration to the closed configuration;
securing tube to the housing using the clamp, wherein the tube comprises a filter attached to an end thereof; and
rotating the lever about the first rotational axis, thereby pushing the pusher towards the clamp such that the plunger is pushed from an inlet end of the tube towards an outlet end of the tube, while moving the lever from the open configuration to the closed configuration.

18. The method of claim 17, wherein the lever is pivotally coupled to the housing by a second axis of rotation, and wherein moving the lever from the open configuration to the closed configuration comprises rotating the lever about the second axis of rotation.

19. The method of any one of claim 17, wherein the second axis of rotation is pivotally coupled to a second lever and the second lever is pivotally coupled to the housing by a third axis of rotation, and wherein moving the lever from the open configuration to the closed configuration comprises rotating the lever about the first axis of rotation and/or about the second axis of rotation.

20. The method of claim 19, wherein moving the lever from the open configuration to the closed configuration comprises rotating the second lever about the third axis of rotation.
